(19) United States
(12) Patent Application Publication
(10) Pub. No.: US 2016/0300193 A1
(43) Pub. Date: Oct. 13, 2016

(54) VERSATILE WEBSITE SOFTWARE APPLICATION FOR INITIATING AN ONLINE DELIVERY OF AN ITEM

(71) Applicant: Edward Halko, Barnegat, NJ (US)

(72) Inventor: Edward Halko, Barnegat, NJ (US)

(21) Appl. No.: 14/681,833

(22) Filed: Apr. 8, 2015

(51) Int. Cl. G06Q 10/10; H04L 29/08; G06Q 10/08; H04L 12/58

(52) U.S. Cl. CPC G06Q 10/1097; H04L 51/10; H04L 67/02; H04L 51/046; G06Q 10/083

(57) ABSTRACT

The present invention relates to implementing a versatile website software application that can be used to initiate an online delivery of one or more items to the intended recipients. The website software application allows the user to select the items to be delivered in various formats and through various mode of shipment. Further, the application can be used to schedule due date on which the selected items can be dispatched to the intended recipients. The website software application supports the selected items in various formats such as an email, a text message, a letter, a gift package, a will agreement, an audio file, a video file or the like. Further, the application ensures that the selected items are shipped to the intended recipients even after the user is away during the shipping due dates. Further, the application allows the user to notify the intended recipients about the stored items.

### FIELD OF THE INVENTION

The present invention generally relates to an online delivering system and more particularly relates to implementing a versatile website software application for initiating an online delivery of an item to intended recipients through various formats and modes.

### BACKGROUND OF THE INVENTION

Web portals are used widely for performing transactions online. Additionally, the web portals can be used to ship items or messages to the intended recipients based on a scheduled date. However, the existing web portal applications are not versatile to handle various formats and mode of shipment to the intended recipients.

Accordingly, there exists a need for a website software application that can support various formats and mode of shipment to the intended recipients.

### SUMMARY OF THE INVENTION

The present invention relates to a system that implements a versatile website software application to initiate an online delivery of one or more items to the intended recipients, wherein the system comprises of: a means to deliver one or more items to the intended recipients as per the schedule defined by a user, a means to pre-arrange one or more items that needs to be delivered to the intended recipients on a special day before the user departs, and a means to setup and designate one or more items that needs to be transferred to the intended recipients.

### BRIEF DESCRIPTION OF DRAWINGS

FIG. 1 illustrates a working overview of a website software application.

FIG. 2 illustrates a web portal initiated on the website software application used for delivering items online.

FIGS. 3a and 3b illustrates an exemplary commercial invoice used for specifying the shipping details to the intended recipients.

FIG. 4 illustrates an exemplary will agreement form used for transferring an asset to the intended recipient.

FIG. 5 illustrates a system overview of components used for implementing the website software application.

### FIGURE DESCRIPTION

100—A network through which the website software application communicates
101—A user intending to use the website software application
102—A website software application used for delivering the items online
103—A list of intended recipients
500—A system overview of components
501—An item list module
502—A delivery module
503—A scheduling module
504—A formatting module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

Throughout the document, the term user or the sender refers to the registered user 101 who intends to avail the delivery service through the website software application 102. The user 101 can register for various options available to deliver items to the intended recipients within the network 100. The options that are available to deliver items to the intended recipients through the website software application 102 are discussed in the document.

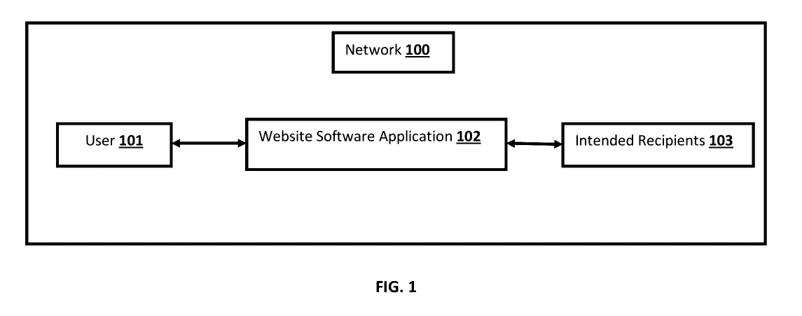

Referring to FIG. 1, illustrates a working overview of a website software application 102. In an embodiment, the website software application 102 that is installed on the electronic device can be used for initiating an online delivery of items to the intended recipients 103 within the network 100. The user 101 registered with the website software application 102 can initiate the online delivery of items in various formats and mode. For example, the user can plan to initiate the online delivery of a message, a card, a gift package, a letter, a birthday wish audio file, a video to congratulate on various occasions. In an embodiment, the website software application 102 allows the user 101 to select one or more recipients 103 to receive the online item that is delivered on a specific day, which can be a future date. The future date for delivering the items can be a scheduled date of the intended recipient 103 and the scheduled date can represent the birthday date, a graduation date, a festival date of the intended recipient 103. In an embodiment, the website software application 102 delivers the selected items on the scheduled date to the intended recipients 103. In an embodiment, the website software application 102 can deliver the selected items to the intended recipients through various forms and modes, for example: the item can be an email message, a recorded telephonic voice, a fax, a postal delivery, a shipment of the agreement, or the like. In an embodiment, the website software application 102 can specify the schedule date for delivering the selected items based on the user's availability within the vicinity. For example, the user can go for a vacation for a long period of time and hence the user may choose to provide one or more schedule dates in the website software application 102 for dispatching the items to the intended recipients 103. The schedule dates can be the birthday dates of the family members of the user. Further, based on the availability of the user within the vicinity, the frequency of dispatching the items to the intended recipients can be scheduled. For example, the service members called for duty can set up and arrange for messages or gifts that are to be sent to their loved ones while they are gone and not able to contact them for long period of time. Sending messages or gifts help to put a smile on their beloved ones faces when the service members are away on duty. Further, the items can be dispatched to the intended recipients on the schedule date for a subsequent period of time after the sender passes away.

In an embodiment, the website software application 102 allows the user 101 or the sender to schedule a specific date on which the intended recipients can receive the pre-recorded or pre-written messages for subsequent years even after the sender passes away. The sender can enter the details of the intended recipients based on which the recipients can retrieve or access the pre-recorded or pre-written messages. In an embodiment, the term retrieving the pre-recorded or pre-written messages implies that the recipient can retrieve the message by entering his/her details in the website software application 102. In an embodiment, the term accessing the pre-recorded or pre-written messages implies that website software application 102 displays the messages to the intended recipients by validating the recipient's details. For example, the intended recipient's name, address, and phone number can be provided by the sender 101 based on which the recipient can retrieve and/or access the pre-recorded or pre-written messages through the website software application 102.

In an embodiment, the website software application 102 allows the user 101 to deliver the items to the intended recipients without tagging the sender's details. For example, the pre-recorded message can be posted by an anonymous sender through the website software application 102 to an intended recipient. In such a scenario, the recipient can access the pre-recorded message without getting the details about the sender 101.

In another embodiment, the website software application 102 allows the user 101 to draft a will agreement when the user is alive and the website software application 102 ensures that the drafted agreement is shipped to the intended recipient 103 as the user or the sender 101 passes away.

In an embodiment, the website software application 102 allows the user 101 to record his/her voice using any of the existing recording applications and transfer the recorded voice to the intended recipients 103 over the network 100.

In another embodiment, the website software application 102 allows the user 101 to record the messages, pictures, or audio file on a recording media such as a DVD, a CD, or a tape and present the recording media to the intended recipients 103 over the network 100.

In another embodiment, the website software application 102 allows the user 101 to record and store messages, pictures, or audio file and enables the intended recipients 103 to access or retrieve the stored items within the network 100. Additionally, the intended recipients 103 can be notified about the recorded and/or stored item that can be retrieved or accessed later by the intended recipients 103.

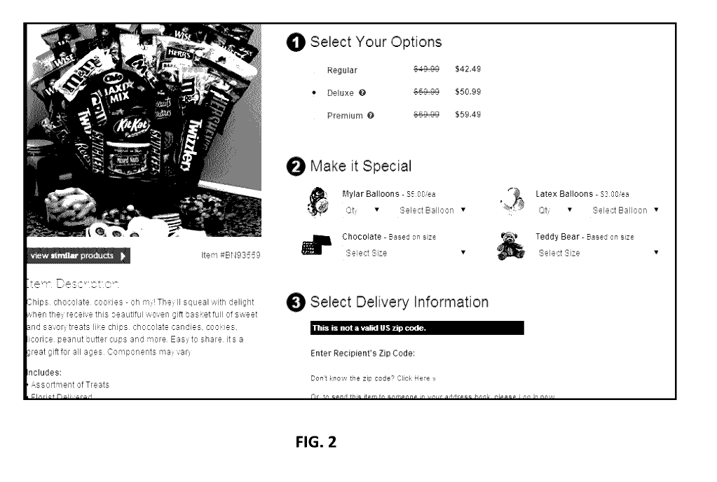

Referring to FIG. 2, illustrates a web portal initiated on a website software application 102 used for delivering gift item online. As depicted in the figure, the website portal allows the user to select the gift items to be shipped to the intended recipient 103. The date on which the gift items needs to be shipped and the delivery related information is provided through the web portal. Based on the information entered, the gift items are delivered to the intended recipients 103 through the website software application 102. For example: the website software application 102 will give the ability for those going away to prison to set up messages for their family or friends and especially to their children and they can also prearrange to send a gift to the child on its birthday either before they leave for prison or after they are gone as the child may get to see them once a month or so.

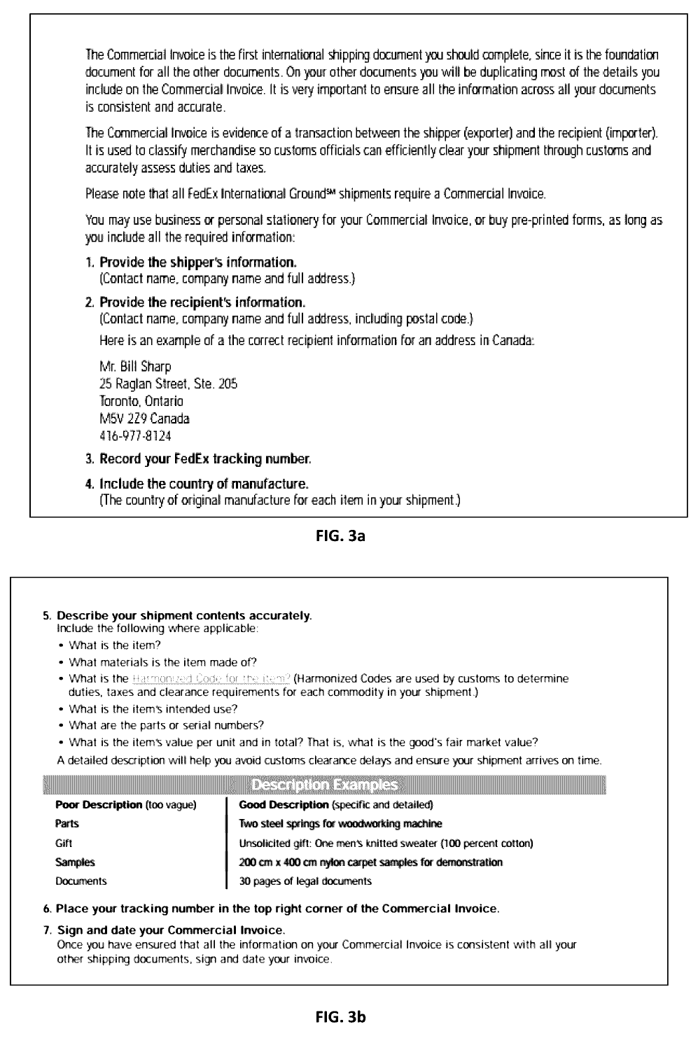

Referring to FIGS. 3a and 3b, illustrates an exemplary commercial invoice used for specifying the shipping details to the intended recipients 103. As depicted in the figure, the website software application 102 allows the user 101 to fill-up the commercial invoice for shipping a consignment to the intended recipients 103. Based on the commercial invoice details provided by the user 101, the website software application 102 ensures that the consignment is shipped as per the schedule and to the required destination.

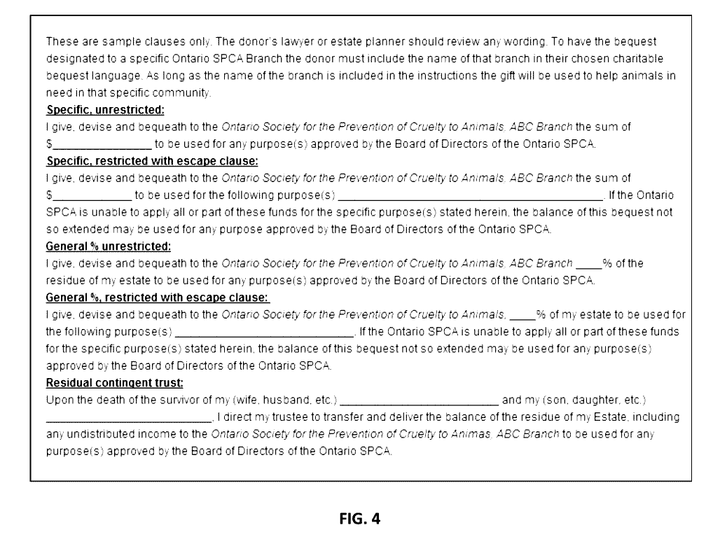

Referring to FIG. 4, illustrates an exemplary will agreement form used for transferring an asset to the intended recipient 103. As depicted in the figure, the will agreement form is used for transferring an estate from a donor to a society for the prevention of cruelty to animals. The website software application 102 allows the user 101 to draft the will agreement and to share the will agreement with the society after the death of the donor. Additionally, the will agreement can be setup for transferring personal belongings, money, gift, or the like to an intended recipient through the website software application 102.

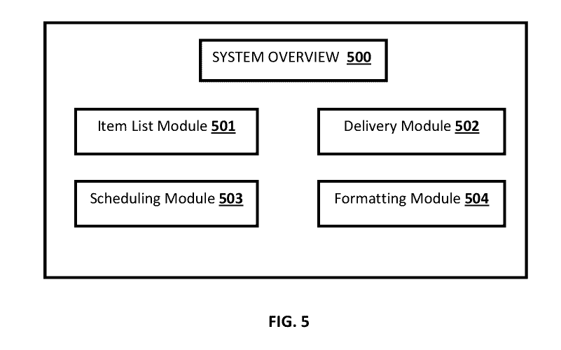

Referring to FIG. 5, illustrates a system overview 500 of components used for implementing the website software application 102. In an embodiment, the website software application 102 comprises of the following components: an Item list module 501, a Delivery module 502, a Scheduling module 503, and a Formatting module 504. In the embodiment, the item list module 501 is configured to provide a list of items selected by the user 101 for delivering the items to the intended recipients 103. In an embodiment, the Delivery module 502 is configured to deliver the selected items to the intended recipients 103 through various formats and modes. In an embodiment, the Scheduling module 503 is configured to schedule the due dates on which the selected items needs to be delivered to the intended recipients 103. In an embodiment, the Formatting module 504 is configured to support the items to be delivered in various formats.

1. A system that implements a versatile website software application to reliably deliver at least one item to at least one intended recipient that is initiated online and as per the registered user's requirement, wherein said system comprises of:
a means to deliver said at least one item to said at least one intended recipient as per the schedule defined by a user;
a means to pre-arrange said at least one item that needs to be delivered for subsequent years to said at least one intended recipient on said at least one special day before said user departs;
a means to setup and designate said at least one item that needs to be transferred to said at least one intended recipient; and
a means to record said at least one item that needs to be delivered to said at least one intended recipient; and
a means to notify said at least one item that is stored for retrieval by said at least one intended recipient.

2. The system as claimed in claim 1, wherein said at least one item that needs to be reliably delivered online can be a pre-recorded message, a pre-written message, a letter, a will, an asset, a gift, a voice recording, a video recording, an image or the like.

3. The system as claimed in claim 1, wherein the schedule defined by said user can be a birthday date, an anniversary date, a graduation date, a festival date, or any other special occasion day associated with said at least one intended recipient.

4. The system as claimed in claim 1, wherein said means of delivering said at least one item online to said at least one intended recipient can be in the form of an email, a message text, a recorded telephonic voice, a fax, a postal delivery, an agreement, or the like.

5. The system as claimed in claim 1, wherein said user may depart from the vicinity of said at least one intended recipient for a short time period, at frequent intervals, a long time period, or permanently and accordingly pre-arrange for delivering said at least one item online to said at least one intended recipient.

6. The system as claimed in claim 1, wherein said means to pre-arrange said at least one item that needs to be delivered to said at least one intended recipient is through selection of a date of shipping of said at least one item before said user departs.

7. The system as claimed in claim 1, wherein said means to setup and designate said at least one item for transferring said at least one item can be through an online written agreement that are agreed upon by both the sender and the recipient.

8. The system as claimed in claim 1, wherein said means to record said at least one item comprises of recording said at least one item on a recording media such as a DVD, a CD, a tape or the like.

9. The system as claimed in claim 1, wherein said at least one item that needs to be delivered to said at least one intended recipient need not be tagged with the sender's details.
